(19) United States
(12) Patent Application Publication
(10) Pub. No.: US 2005/0086533 A1
(43) Pub. Date: Apr. 21, 2005

(54) Method and apparatus for providing secure communication

(76) Inventor: Vincent W. Hsieh, Cupertino, CA (US)

Correspondence Address: JEFFREY HALL, 212 CLINTON ST, SANTA CRUZ, CA, 95062, US

(21) Appl. No.: 10/783,229

(22) Filed: Feb. 20, 2004

Related U.S. Application Data
(60) Provisional application No. 60/512,948, filed on Oct. 20, 2003.

(51) Int. Cl. H04L 9/00

(52) U.S. Cl. 713/201

(57) ABSTRACT

A method for providing secure communication in a computer network is disclosed, A method and a computer program product for secure communication, referred to as the secure proxy protocol, where, two or more clients communicate securely via a communication server.

### CROSS REFERENCE TO RELATED APPLICATIONS

### 37 C.F.R. 1.77

This application is related to and claims priority from U.S. Provisional Patent Application 60/512,948, filed Oct. 20, 2003.

### BACKGROUND OF THE INVENTION

### 37 C.F.R. 1.77(a)(7)

1. Field of Invention

The present invention relates to a secure communication methodology, and an approach for establishing secured “proxy” communication sessions between two or more clients allowing them to communicate via a communication “proxy” server. More specifically, the present invention relates to a secure communication method that can operate in the restricted but practical network environments, using one or more protocols, using only one communication port.

2. Description of the Related Art

Conventional secure communications methods are typically based upon connecting remote clients using “network layer” (or layer 3 in the ISO networking standards) secure protocol, or, “application layer” (or layer 7 in the ISO networking standards) secure protocols. An example of a “network layer” secure communication is IPSec VPN. An example of “application layer” secure communication solution is SSL VPN or Secure Socket Layer protocol based Virtual Private Network. Such types of access models suffer from several significant limitations.

In the following, Virtual Private Network (VPN) refers to either or both IPSec based VPN and SSL based VPN. First, conventional secure access models are very complex and costly to deploy and support. The conventional secure access models may require the installation of both access client software and application software on the remote client to provide access to applications and resources on the “server” , or another “client”. An example that illustrates this limitation is the use of VPN to provide remote client access. In this case, clients go to a home PC and initiate a VPN connection using the pre-installed VPN client software, connect to a PC inside of the corporate network. The clients launch an application that was pre-installed on the home PC to access document or application server back on the office PC. The clients may have an application in-mind to use, but there is no guarantee that the application is installed on the home PC at the time. Therefore, even that the clients may have the necessary network accesses, the clients still may not be able to use the application, since it not installed on the home PC. Moreover, access locations may be inconvenient and limited for the clients. The clients may need to access from a location other than home, such as in hotels or conferences, or from an airport Kiosk or a customer site. Even though there may a PC (or Kiosk) available, the VPN client software may not be present. Even if the VPN client software is present, the application intended may not be installed on the PC (or Kiosk).

Second, conventional secure access models may not provide sufficient security. Network layer secure access method such as that provided by IPSec VPN allows too much access once connected with IPSec VPN, VPN clients become part of the company networks and have direct network access to network resources. Access control is provided at the network IP address level. There is no client or resource level access control. Furthermore, there is no end-to-end security. Since security is only as strong as the weakest link. To ensure security, all of the elements need to be considered, to ensure end-to-end security. End-to-end security includes security for the access client, security for the target (PC or server), and the network security for the communication between the client and the target (PC or server). The conventional secure access models require the necessary client security to provide secure access. However, these security measures may not be sufficiently protecting the access. An example that illustrates this limitation is the use of VPN to provide email access. Clients launch an email application on the home PC with personal firewall and anti-virus protections properly installed. A new virus (one that has not been identified and provided signatures/solutions for) bypass the protections and travel into the corporate email server via the VPN or SSL VPN then to other PCs connecting to the corporate network by way of the remote email access. Another example that illustrates this limitation is the use of VPN to provide remote PC access. Even though the communication is secure between the access client and the VPN gateway. The communication between the VPN gateway and the target (PC or server) may not be secure. Client passwords and sensitive data are transmitted in “clear” (unencrypted) and can be easily acquired by third parties, such as by using public domain network “sniffer” software readily available on the Web.

Third, conventional secure access models may be limited in reach or may not operate consistently in the presence of network firewalls and proxies. The conventional secure access models require certain necessary communication port(s) to be activated and enabled on corporate firewalls and proxies on both the source network and the destination network. However, network security policies for firewalls and proxies vary from organizations to organizations and from companies to companies.

In practical networking environment, the restricted but practical firewall/proxy configuration is: No inbound connection allowed, and only allows outbound connection to the HTTP port (80) and the SSL port (443) through proxy server. A transparent communication method has to work within such constraints.

An example that illustrates this limitation is the use of VPN to provide access from inside of the firewall. Clients launch a VPN connection from inside the corporate firewall to another PC or server inside the firewall of another company. The connection request travels from the local PCs, pass the corporate firewall (with the correct firewall and proxy configurations on the source network for the VPN), reach the firewall of another company, and the connection is rejected by the second firewall on the destination network. Since the destination firewall has different security and configuration settings than the client source network. Another example that illustrates this limitation is the use of display client (e.g. Citrix, VNC, pcAnywhere, or Windows Remote Desktop Access “RDA”). Clients launch a connection from inside the corporate firewall to another PC or server inside the firewall of another company. The display client uses one or more ports, these port(s) may or may not be standard secure port(s) (such as SSL port 443) to make connection, and/or pass control messages, and to send data. The connection may fail for the same reasons as in the previous example. Yet another example that illustrates this limitation is the use of on-line conferencing tools (e.g. NetMeeting). Clients launch a meeting session from inside the corporate firewall to another PC or server inside the firewall of another company. The tool uses 2 or more ports, one (or more) to make connection, and/or pass control messages, and the other(s), to send data. The connection may fail for the reasons that it failed to pass the firewall/proxy restrictions.

Given the current demand for secure, ubiquitous access and the limitations in the prior approaches, an approach for secure remote access that does not suffer from limitations associated with conventional secure access models is highly desirable.

In particular, an approach for true “clientless” access that allows remote access without the need to install access software or application software on the access client is highly desirable. There is a further need for true “ubiquitous” access that allows access from anywhere—any location, any platform; to anywhere—any destination, with any application, is highly desirable.

As used herein, a client(s) is defined as any computing device, or device with the ability to store a computer program, computer program, or user of such device.

There is a further need for an approach for ′secure” communication that allows end-to-end network security from the access client to the target client (or server). There is a further need for an approach for “secure” access that allows end-to-end network security from the access client to the target client (or server), as well as client security that eliminates the security risks of viruses, worms, backdoors, and leaving trails behind access.

There is a further need for an approach for “secure”, ‘ubiquitous”, true “clientless” access. One that allows “secure” access that provides end-to-end communication security. One that also allows true “ubiquitous” access that provides access from anywhere—any location, any platform; to anywhere—any destination. One that also allows true “clientless” access that provides remote access without the need to install access software or application software on the access client.

There is a further need for an approach for “secure”, ‘ubiquitous, true “client” access. One that allows ‘secure” access that provides end-to-end communication security, as well as client security that eliminates security risks of viruses, worms, backdoors, and leaving trails behind access. One that also allows true “ubiquitous” access that provides access from anywhere—any location, any platform; to anywhere—any destination, any application. One that also allows true “clientless’ access that provides remote access without the need to install access software or application software on the access client.

There is a further need for an approach to centrally manage the “secure”, “ubiquitous”, true “clientless” access without the burden of extensive administration or resource, security, and clients.

### BRIEF SUMMARY OF THE INVENTION

### 37 C.F.R. 1.77(a)(8)

A method is provided herein for establishing secured communication, in a computer system or network where, two or more clients communicate via a communication server. The method uses a single communication port such as SSL port 443.

The present method allows for an improved means for establishing secured communication, where, two or more clients communicate via a communication server using a “Secure Proxy” protocol or method.

### BRIEF DESCRIPTION OF THE DRAWINGS

The accompanying drawings, which are incorporated in and constitute a part of the specification, illustrate a preferred embodiment of the invention and, together with a general description given above and the detailed description of the preferred embodiment given below, serve to explain the principles of the invention.

FIG. 1 shows schematically the effect of using the methodology of the present invention sending a secured message via the internet, according to the invention.

FIG. 2 shows prior methodology using the internet to send a secured message.

FIG. 3 shows prior methodology of having limited access and location due to firewall and proxy port restrictions, outbond connections allowed=80, 443, inbound connections=none.

FIG. 4 shows the methodology of the present invention in comparison to prior methodology shown in FIG. 3 where the “Secure Proxy” protocol using one port, SSL port 443 is illustrated, according to the invention.

FIG. 5 is a flow chart illustrating the preferred steps of establishing secure communications, according to the invention.

FIG. 6 is a flow chart illustrating the preferred handshake in authentication the client, establishing a secured communication channel between the client and the server, according to the invention.

### DETAILED DESCRIPTION OF THE INVENTION

### 37 C.F.R. 1.77(a)(10)

Reference will now be made in detail to the present preferred embodiments of the invention as illustrated in the accompanying drawings.

In accordance with the invention there is provided an improved method for establishing secured communication, where, two or more clients communicate via a communication server using a “Secure Proxy” protocol that allows “secure” communication with end-to-end network security from the access client to the target client.

As previously discussed, as used herein and in the figures, a client(s) is defined as any computing device, or device with the ability to store a computer program, computer program, or user of such device or program.

The present method provides an improved means for establishing secured communication, where, two or more clients communicate via a communication server using the “Secure Proxy” protocol communication described herein, that allows true “ubiquitous” access from anywhere—to any location, any platform; to anywhere—any destination, without the need to know the locations or network addresses of the target client.

The present invention provides an improved method for establishing secured communication, where, two or more clients communicate via a communication server using a “Secure Proxy” protocol, preferably using a single communication port, that allows “secure” communication with end-to-end network security from the access client to the target client, and true “ubiquitous” access from anywhere, any platform; to anywhere, any destination.

The present method may be used for establishing secured communication, where, two or more clients communicate via a communication server using a “Secure Proxy” protocol, that allows “secure” access with end-to-end network security from the access client to the target client, as well as client security that eliminates security risks of viruses, worms, backdoors, and leaving trails behind access, and true “ubiquitous” access from anywhere, any platform; to anywhere, any destination, any application, and, to provide true “clientless” access that allows remote access without the need to install access software or application software on the access client.

Accordingly, the present method provides a means for centralized management of all secure communication, where, two or more clients communicate via a communication server, to enable consistent security management, and without the burden of extensive administration.

The present invention provides a secure communication method, for establishing secured communication session between two or more clients communicating via a communication server. The method is preferably implemented through by a computer program in a computer network or computer system, and is particularly useful in internet applications. The present method utilizes a single communication port In addition, the present invention relates to a secure communication method for establishing secured communication between two or more clients communicate via a communication server that can operate transparently in the most restricted but practical network environments.

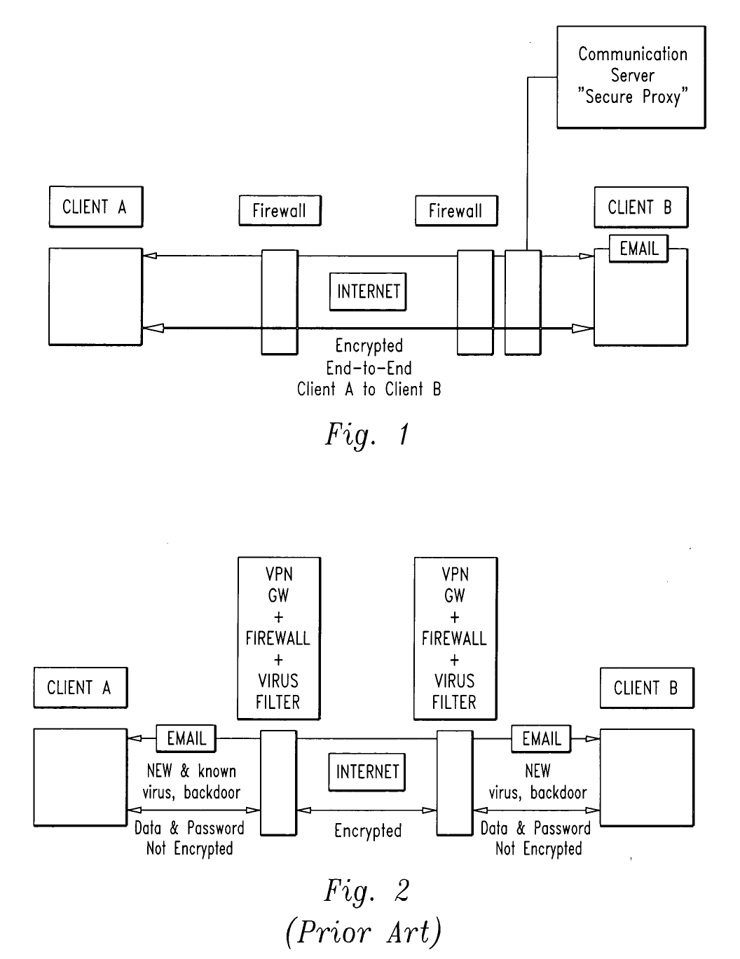

In FIG. 1 a preferred implementation of the present method is shown, sending a secured message via the internet, according to the invention. FIG. 2 shows a comparative illustration of prior methodology using the internet to send a secured message.

In current networking environment, the practical yet most restricted firewall/proxy configuration is: No inbound connection allowed, and only allows outbound connection to HTTP port 80 and SSL port 443 through a proxy server using CONNECT proxy method. A transparent communication method has to work within such an environment. If the method works in such an environment, it should work in any other less restricted environments.

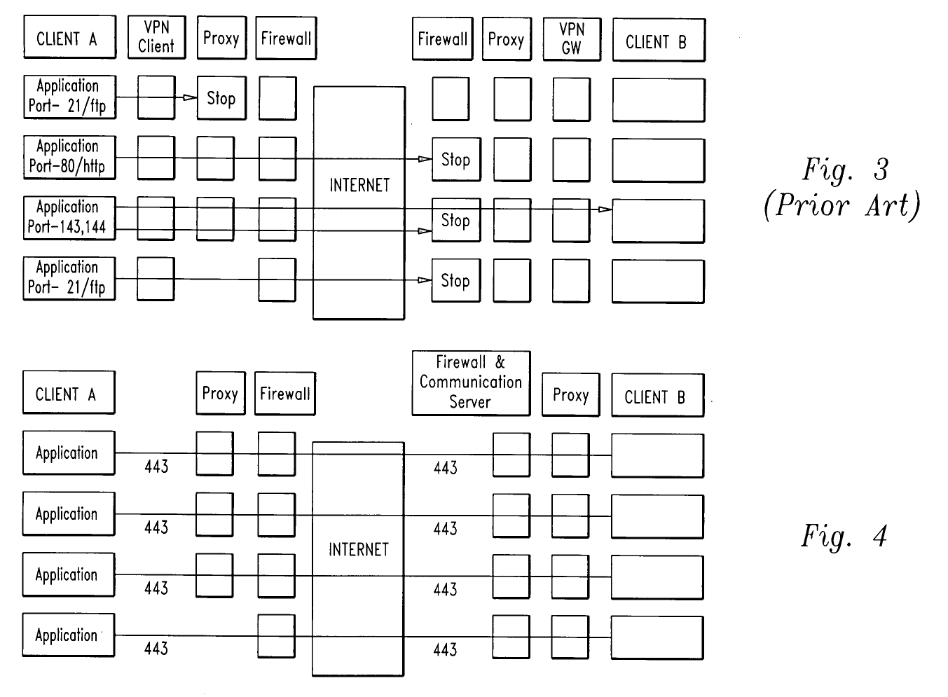

As seen in FIG. 3 prior communication methodology has both limited access and location due to firewall and proxy port restrictions, outbound connections allowed=80, 443, inbound connections=none.

With reference now to FIG. 4, a comparative illustration shows the methodology of the present invention in comparison to prior methodology shown in FIG. 3 where the “Secure Proxy” protocol using one port, SSL port 443 is illustrated, according to the invention.

The preferred methodology used to achieve this transparent communication is termed herein, the “Secure Proxy” protocol or method.

In following descriptions, a single (one) communication port, such as the SSL TCP/IP port 443, is used 29, for all of the communications. To simplify discussions, the SSL port 443 will be used in the following. However, it is understood that using the method of the present invention, other single ports may be used, however, the preferred port is SSL port 443.

The term “network proxy”is used to denote the network proxy server deployed in corporate network environments. Examples of these “network proxy” server are: Socks Proxy Server and Squid Proxy Server. To distinguish it from the term used in the invention—“Secure Proxy” protocol, the term “Communication Server” is used instead.

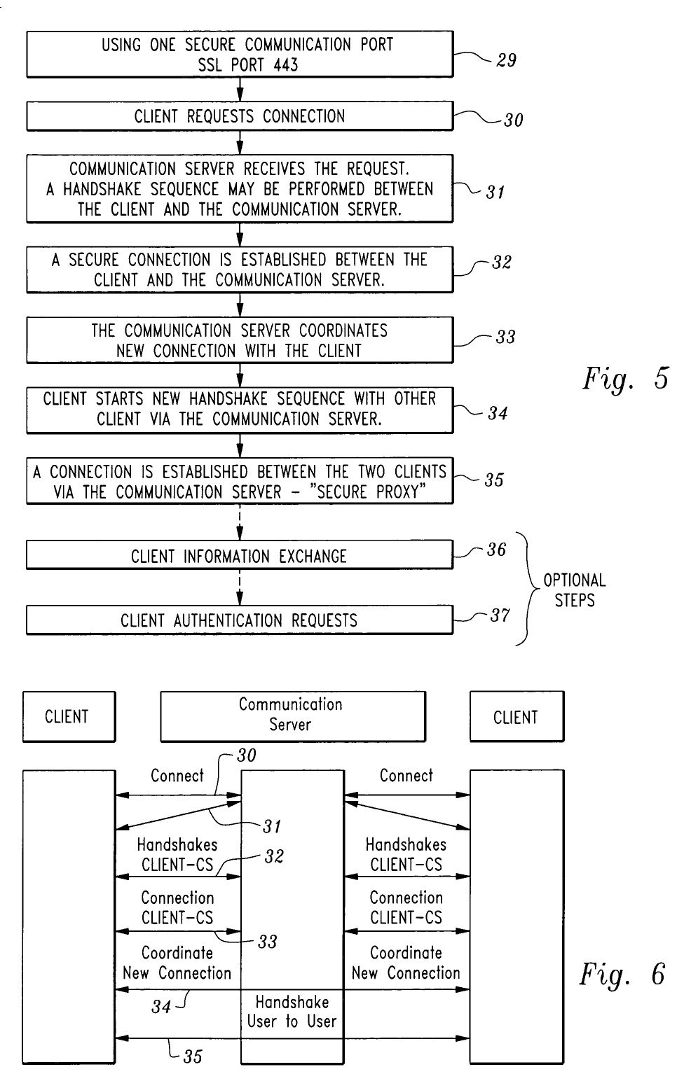

In FIG. 5, the client, where a network proxy is not present or not required: Using a single secure port 29, such as SSL port 443, the client makes connection request 30, or other types of request, for example see below as to the communication server. This is also seen in FIG. 6.

The client, where network proxy is present or required: The client detects network proxy settings for outbound connection in its current network environment. The client makes a connection request to the communication server. If no proxy server is configured, the client makes direct connection request to port 433 to the communication server. If the proxy server is configured, the client requests the proxy server to forward its connection request.

Preferably, the Communication Server: Listens on port 443 for requests 31, using a function, such as the Socket lListen ( ) function. The client connection requests preferably comprise receiving a connection request from the client and the communication server accepts the connection. A network protocol handshake, such as SSL handshake, may be performed between the client and the communication server. A secure network connection 32, is established between the client and the Communication Server,

Connection requests of one client to the other, preferably comprise: the Communication Server looks up the client information, and either allows or denies the connection based on the client authorization information. The Communication Server coordinates 33, with both clients, to start a new network protocol handshake, such as the SSL handshake.

While the communication server will not respond to, nor start new secure connection handshake sequence 34, such as SSL, with either client, it relays (proxies) the data communications exchange between the two clients. Thus the two clients form a secure connection, such as SSL, between themselves. The two clients may then communicate securely over this “Secure Proxy” connection 35.

Client information exchange 36, is preferably provided by the client information being passed to the Communication Server, such as system name/ID, and network address. The Communication Server may then use these information to identify this client, provide transparent access from others to this client, and to provide access control. This exchange may take place in different ways, at different times, by the choices of the client of the protocol, it may also be omitted

Depending on the types of client application protocol used, there can be further application level protocol exchanges. For example, the Client Authentication requests 37, may be provided by having the Communication Server serves the authentication request. Other client protocol requests may also be utilized such as the Communication Server may process other application protocols by analyzing the application protocol packets received from client. The Communication server then serves the protocol accordingly. For example, client may send a HTTP request; the Communication Server will serve the request by functioning as a HTTP server.

Using the “Secure Proxy” protocol as herein described, a secure communication between two or more clients communicating via a communication server may be established. Such communication is secure in the computer system or network and internet communications. Several possible forms of communication sessions may be established. For example, a one-to-one communication session where one client communicates with another client via a communication server. A one-to-many communication session where one client communicates with two or more other clients via a communication server. A many-to-many communication session where two or more clients communicate with two or more other clients via a communication server.

In operation and use the present invention provides end-to-end network security. This end-to-end security allows enhanced network security from client to communication server, communication server to (target) client, and client to client communications using a secure network protocol such as SSL.

The present methodology provides an improved method for establishing secured communication, where, no direct network access from one client to the other is allowed. All access is managed and controlled by the communication server, and client and resource level access control may be enforced. The method allows for establishing secured communication, where, network and system performance may be enhanced. The clients and communication server may exchange information that does not require data encryption and/or decryption by the communication server.

Using the present methodology allows for an improved way of establishing secured communication, where clients and communication server may exchange information that can be centrally managed. These include the security policy and access log that are required to provide simplified central security management.

In use, the present methodology provides an improved means for establishing secured communication, where access transparency, ubiquitous access—from any location, to any destination) may be enhanced. Using “One Port”, such as the SSL port 443, access limitations dues to “communication port” restrictions imposed by firewall/proxy, and inconsistent firewall/proxy port configurations may be removed. For example, access from behind the firewall/proxy given the practical but most restricted configurations, to destinations behind the firewall/proxy given the practical but most restricted configurations may also be realized.

By providing such improved methods for establishing secured communication, where access transparency, ubiquitous access—from any location, to any destination, for client applications may be enhanced. Applications normally not able to traverse firewall/proxy due to port restrictions, using non-secure port(s), using more than one ports; by using the “Secure Proxy” protocol, may no longer be limited to their access, and may able to provide access given the practical but most restricted firewall/proxy configurations.

This also allows for greatly enhanced security and network performance. Using a secure communication port, such as the SSL port 443, may reduce network attacks. Secure ports are normally better protected. By comparison, non-secure, popular communication ports, such as the HTTP port 80, FTP port 23, are common targets of hackers and attract a large number of network attacks. Using a secure communication port and especially, a single secure port greatly reduces the chance of being bombarded with network attacks, traffic, and thus the chance of being compromised.

By using the present “Secure Proxy” protocol described herein, one or more protocols may use one communication port, where, two or more clients communicate securely via a communication server. Using this method security may be enhanced. There is no direct network access from one client to the other. All access is managed and controlled by the communication server, and client and resource level access control may be enforced.

It is also apparent that by using the “Secure Proxy” protocol herein described, security may be enhanced. End-to-end network security from access client to the target client may be enforced. This end-to-end security includes but is not limited to client authentication, and network security such as that provided by a secure network protocol like SSL. This end-to-end security allows enhanced network security for client to communication server, communication server to target client, and client to client communications.

Using the “Secure Proxy” protocol described herein, network and system performance may be enhanced. The client and communication server may exchange information that does not required decryption by the communication server. As an example, one client encrypts the data, send it to the communication server, without decrypting the data packet, communication server sends the data packet to another client, the destination client decrypts the data packet. The performance of the communication server and the overall communication time is significantly improved comparing the present invention to other solutions that require the additional processing on the communication server. An example to illustrate this limitation is that in a different approach, one client encrypts the data, send it to the communication server, the communication decrypting the data packet, examine the content of the packet to decide which target client the packet should be delivered to, encryption the packet, communication server sends the data packet to another client, the destination client decrypts the data packet. The performance of the communication server and the overall communication time is significantly improved comparing the present invention to other solutions that require the additional processing on the communication server.

Using the “Secure Proxy” protocol of the present methodology, security management may be enhanced. The clients and communication server may exchange information that can be centrally managed. These include the security policy and access log that are required to provide simplified central security management. Another benefit of the invention is that using “One Port”, access transparency ubiquitous access—from any location, to any destination may be enhanced. Using “One Port”, such as the SSL port 443, access limitations dues to “communication port” restrictions imposed by firewall/proxy, and inconsistent firewall/proxy port configurations may be removed. For example, access from behind the firewall/proxy given the practical but most restricted configurations, to destinations behind the firewall/proxy given the practical but most restricted configurations may also be realized.

In practical networking environment, the restricted but practical firewall/proxy configuration is: No inbound connection allowed, and only allows outbound connection to the HTTP port 80 and the SSL port 443 through proxy server. A transparent communication method has to work within such constraints. Using the present method, access transparency, ubiquitous access—from any location, to any destination, for client applications may be enhanced. Applications normally not able to traverse firewall/proxy due to port restrictions, using non-secure port(s), using more than one ports; by using the “Secure Proxy” protocol, may no longer be limited to their access, and may able to provide access given the practical but most restricted firewall/proxy configurations.

Accordingly, using a single security port or “One Port” for all communication may allow enhanced security and network performance. Using secure communication port, such as the SSL port 443, may reduce network attacks. Secure ports are normally better protected. By comparison, non-secure, popular communication ports, such as the HTTP port 80, FTP port 23, are common targets of hackers and attract a large number of network attacks. Using a secure communication port and especially, a single secure port greatly reduces the chance of being bombarded with network attacks, traffic, and thus the chance of being compromised.

As is evident from FIGS. 1-6, and the above description, a wide variety of secure communication applications and systems may be envisioned from the disclosure provided. The methodology described herein is applicable in any computer system, computer network, internet and non-internet based communications, and additional advantages and modifications will readily occur to those skilled in the art. The invention in its broader aspects is, therefore, not limited to the specific details, representative apparatus and illustrative examples shown and described. Accordingly, departures from such details may be made without departing from the spirit or scope of the applicant's general inventive concept.

1. In a computer system, a method for secure communication, comprising:
using a single secure communication port for secured communications between a server and a client, and between two clients, for ease of access and transparency, from any location to any location, within said computer system.

2. The method of claim 1, wherein said single secure communication port is SSL port 443.

3. The method of claim 1, wherein said single communication port allows access from behind firewalls by establishing a secure proxy communication between said two clients.

4. The method of claim 1, wherein said single communication port allows access inside firewalls by establishing a secure proxy connection between said two clients.

5. The method of claim 1, wherein said single communication port allows ease of management by establishing a secure connection between said two clients.

6. The method of claim 1, wherein said single communication port allows the elimination of a need to change firewall configurations by establishing a secure proxy communication between said two clients.

7. A method for secure communication in a computer network, comprising:
using a single secured communication port for secured communications within said computer network, for establishing secured communication between two or more clients via a communication proxy server.

8. The method of claim 8, wherein said single secured communication port is SSL port 443.

9. A method for secure communication in a computer system, comprising the steps of:
using a single secure communication port;
requesting communication by a client for connection to a communication server;
receiving said connection request and a handshake sequence is performed between said client and said communication server;
coordinating a new connection with the client by the communication server;
initiating a handshake sequence with a second client via the communication server; and
establishing a connection between the two clients via the communication server.

10. The method of claim 9, wherein said single connection port is SSL port 443.

11. The method of claim 9, wherein a single communication protocol using said single secure port is used.

12. The method of claim 9, wherein multiple protocols using said single secure communication port are used.

13. The method of claim 11, wherein said single secure communication port allows access from behind firewalls by establishing a secure proxy connection between two clients.

14. The method of claim 11, wherein said single secure communication port allows access inside firewalls by establishing a secure proxy connection between two clients.

15. The method of claim 11, wherein said single secure communication port allows ease of management by establishing a secure proxy connection between two clients.

16. The method of claim 11, wherein said single secure communication port eliminates the need to change firewall configuration by establishing a secure proxy connection between two clients.

17. Computer software for a secure communication in a computer system, comprises:
means for using a single secure communication port for secured communication within said computer system for establishing secured communications between two or more clients.

18. The computer software of claim 17, wherein said single secure port is SSL port 443.
